(19) United States
(12) Patent Application Publication
(10) Pub. No.: US 2002/0142842 A1
(43) Pub. Date: Oct. 3, 2002

(54) Console-based system and method for providing multi-player interactive game functionality for use with interactive games

(76) Inventors: Gregory W. Easley, New York, NY (US); Edmund A. Moulton, New York, NY (US); Jim Schoenburg, New York, NY (US); Tim Arnold, New York, NY (US)

Correspondence Address: Brian M. Buroker, Esq., Hunton & Williams, Suite 1200, 1900 K Street, N.W., Washington, DC, 20006, US

(21) Appl. No.: 09/819,603

(22) Filed: Mar. 29, 2001

(51) Int. Cl. A63F 9/24

(52) U.S. Cl. 463/42

(57) ABSTRACT

A console system for operating at a central server in communication with remote user devices that may be individually addressable such as Internet user devices and digital television set-top boxes. The console system provides a set of predetermined base-functionality modules that may be leveraged by interactive games provided through various software game modules. The console system may provide functionality related to email, registration, economy/prize system, reporting, error handling and other functions, for example. The software game module provides game specific functionality that selects the base functionality and passes the base functionality parameter values to indicate operation of the software game over the interactive game network.

### FIELD OF INVENTION

The present invention relates to a console system provided by a server to enable functionality for interactive games through digital television, online television, the Internet and other forms of output where one or more players may participate in the interactive games.

### BACKGROUND OF THE INVENTION

Interactive games are becoming more popular among Internet and other users. As graphics and sound quality continue to advance, users are finding interactive games to be more entertaining, challenging and competitive. Through the use of the Internet, players across the country (and around the world) are able to compete against each other in real-time.

Games based on real-time events have also become more popular among viewers. Interactive games based on real-time events enable viewers to enjoy competition with other players and become virtual participants in the actual event. Real-time events may include award shows (e.g., competition to select the most winners, etc.), sporting events (e.g., fantasy games, competition to guess the next play, etc.), reality shows (e.g., out-survive other contestants), game shows (e.g., competition to win prize money, etc.) and other events.

Traditionally, individual games may be provided as software stored on a hard storage device (which may include disks, floppies, CDs and other cartridge storage devices). A client-side terminal system interacts with the cartridges and communicates with a central system. Most of the processing occurs on the client-side system. Each game application may also provide options and services (e.g., game specific options, general options including email, chat, registration, etc.) that are exclusively associated with a particular game application. These options and services are generally not compatible with other software and game applications. For example, each game application may provide separate email functionality.

Generally, client-side game systems are inflexible and difficult to upgrade. Oftentimes, an entire new client-side system is required to adapt to advances in graphics, sound quality, and other improvements and enhancements. Also, older cartridges may not be compatible with newer (e.g., upgraded) client-side systems. Thus, participation in such game applications is inefficient and expensive.

These and other drawbacks exist with current systems.

### SUMMARY OF THE INVENTION

Additional advantages of the invention will be set forth in part in the description which follows, and in part will be apparent from the description, or may be learned by practice of the invention. The objects and advantages of the invention may be realized and attained by means of the instrumentalities and combinations particularly pointed out in the appended claims.

The present invention relates to a console system for operating at a central server in communication with remote user devices that may be individually addressable (e.g., Internet user devices, digital television set-top boxes, etc.). The console system may provide a set of predetermined base-functionality modules that may be leveraged by interactive games provided through various software game modules. The console system may provide functionality related to email, registration, economy/prize system, reporting, error handling and other functions, for example. Various software game applications (e.g., software game modules) may communicate with the console at the central server to provide interactive functionality with remote users. The remote users may access the central server from a user device which enables the remote user to provide inputs to complete parameters expected by the interactive game. By providing base-functionality in a console system, new interactive games as well as modifications to existing games are easier to develop and implement because changes are made to the software game module. The software game module provides game specific functionality which selects the base functionality needed from the base functionality modules and passes those modules parameter values according to how the operation is desired.

In particular, base functionality provides the functionality for multi-player game applications where remote players compete against each other in real time. According to an embodiment of the present invention, the console system may provide gateway and lobby functionality. For example, a gateway may provide a list of lobbies with functionality to limit the number of players in each lobby. In each lobby, a list of games and/or players, chat capabilities and/or other services may be provided, for example. From the lobby, participants may enter specific game sessions, from a selection of a plurality of games provided in the different lobbies. A game server may provide game applications with interactive capabilities and other features. The console system also provides game scoring/participation functionality including scoring, points, chat, branding, advertisements and other cross-game functionality.

The console system may also provide trivia functionality for use by trivia-based games with databases of questions, categories, difficulties and other parameters that individual software game modules may pass to the console system for operation. Prediction functionality may also be provided for predictive games. Individual software game modules may then pass parameters to the console system to indicate earned and spent points, user login, chat messages and other relevant information.

The accompanying drawings, which are incorporated in and constitute a part of this specification, illustrate various embodiments of the invention and, together with the description, serve to explain the principles of the invention.

### BRIEF DESCRIPTION OF THE DRAWINGS

FIG. 1 is a diagram of an overall system for providing interactive games based on real-time and other events, according to an embodiment of the present invention.

FIG. 2 is a block diagram of a console system, according to an embodiment of the present invention.

FIG. 3 is an example of a screen shot of a gateway, according to an embodiment of the present invention.

FIG. 4 is an example of a screen shot of a lobby, according to an embodiment of the present invention.

FIG. 5 is an example of a screen shot of a game application, according to an embodiment of the present invention.

FIG. 6 is a flowchart illustrating a method of participating in an interactive game, according to an embodiment of the present invention.

### DETAILED DESCRIPTION OF THE PREFERRED EMBODIMENTS

A console system is provided at a central server that provides a backbone layer with a series of services that may be accessed, as requested by individual software game modules. The individual software game modules leverage the console system for various functions and options (e.g., base components, multi-player components, independent game components, etc.). Software game modules may pass parameters to the console system to provide various interactive and informational data, such as earned and spent points, user login, chat messages and other relevant information. The server may retrieve data provided by a software game module in a specified format. In response, the server may provide data for the user to act upon or respond to at a remote user system.

Services that may be used by several different games may be provided by the server system of the present invention while game specific information may be provided as a separate software game module. The console system may be concerned with information relevant to selected functions. In particular, the server may request specific information that the console system may use (or need) to perform specific tasks. As various types of services and functions may be available at the server, specific functions requested (or selected) by the user (or software game module) may be accepted and processed by the console system and subsequently forwarded to the user. The server may be configured to optimize access to components (e.g., functions, services, etc.) that are requested, required and/or featured in a selected game application which may be downloaded by the user. For example, shockwave games that receive and pass parameters via Common Gateway Interface (CGI) may be able to access the game services in a similar manner as a native Java program or other programming language.

Software game modules may be provided at the server or retrieved by the server from a separate location (e.g., remote system, website, other sources, etc.). For example, at the request of the user (or otherwise requested), the server may retrieve software game modules from other locations or independent sites. The software game modules may send information (e.g., parameters) to the console system to invoke appropriate functionality. The console system may process the information and enable the user to interact with the game application and perform other operations.

According to another embodiment of the present invention, the system may provide a flexible system for engaging interactive game applications and other services. A software game module may select to use some of the services of the system, but not others. For example, single player games may not use multi-player components of the console system. According to another example, a graphical twitch (or other reflex game) game, unlike a 10 question trivia game, may not access a trivia service available through the server. As a result, resources may be utilized efficiently and economically because multiple software game modules may leverage common server based console modules at the same time. In addition, the present invention may support various administrative tools (e.g., game tools, system tools, etc.) for ease of changing various aspects of the game application.

The system of the present invention may provide an application programming interface for games, defining some or all parameters passed by a console system and/or services to a game application and also defining the parameters expected in return. As a result, the console system may be ignorant of the games and their functionality, and focus on the parameters supplied.

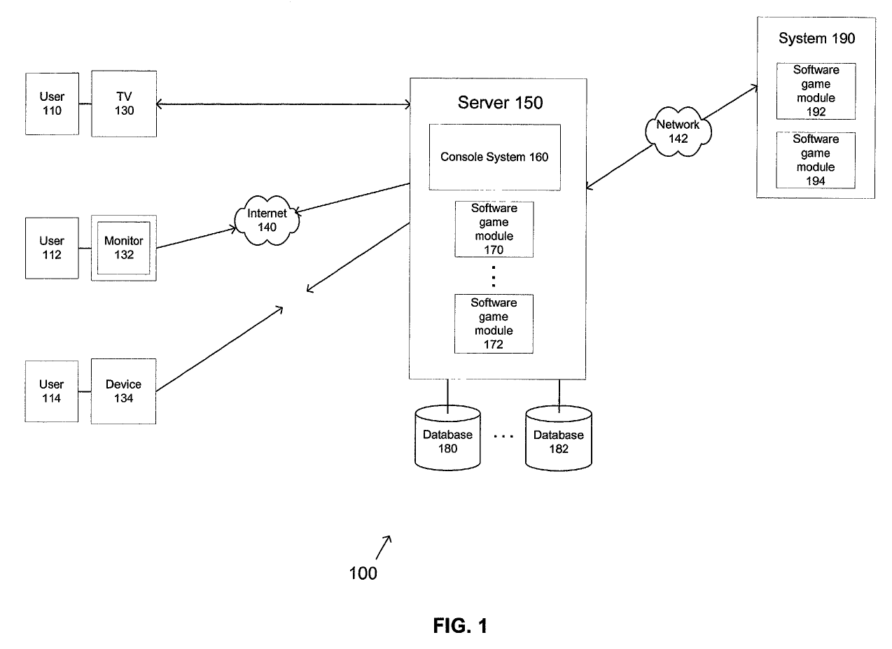

FIG. 1 illustrates an example of an overall system, according to an embodiment of the present invention. Various users may access the system of the present invention, as illustrated in FIG. 1. For example, user 110 may access software game modules 170, 172 at the server 150 via a user display device. In addition, a series of servers may be implemented. Other types of modules may also be accessed for interactive capabilities. User display devices may include a television 130, computer monitor 132 and/or other devices capable of communicating with server 150, via telephone lines, cable lines, WAP, Internet, and other modes of communication.

For example, the game application may be displayed on a television component 130. According to an embodiment of the present invention, interactive applications may be accessed through digital televisions, other interactive televisions and display devices. For example, television component 130 may include a digital television set-top box. For example, interactive play may be established through access to a digital satellite system. In another example, a display device may include a television coupled to a communication network including a cable line with a cable box which allows a viewer to send information to a system. In another example, a tuner may enable viewers to receive and display digital television images, including High Definition TV (HDTV) and analog broadcasts in an interactive environment.

User input devices may also be implemented with user display devices to communicate input to the server. For example, user input devices may include a remote control, keyboard, voice activated device, joystick, mouse and other forms of input. User devices may receive input from the user where input information may be passed to the console module at the central server to access various software game modules and/or functions.

In another example, a user, as illustrated by 112, may access a game or other application through software game module 170, 172 via computer monitor 132 through the Internet 140. A wireless Internet device may also be implemented. A personal computer or network computer may access the system/of the present invention.

In another example, a user, as illustrated by 114, may access a game or other application, for example, via a wireless device 134. Wireless device 134 may include a laptop, PDA, cell phone, or other compact device with wireless access to the system of the present invention. Other users and modes of communication may be utilized by the present invention.

Game applications may be accessed through a website (or other user interface) where software (plug-ins or other applications) may be downloaded or otherwise accessed through the present invention from server 150 or other systems, such as system 190. Generally, information related to how the game works, what is a good move, bad move, scoring for the game and other game specifics may be provided as part of the software game module. Other examples may include simultaneous versus turn-based game play as well as real time data updates or game state updates.

System 100 of the present invention may include various combinations of server 150, console system 160, software game modules 170, 172, databases 180, 182 and other components. In addition, server 150 may have access to other software game modules 192, 194 at system 190 through network 142 or other modes of communication.

Server 150 may communicate with remote users, such as 110, 112, and 114, via remote user devices that may be individually addressable, through various modes of communication. Server 150 may receive various types of user inputs, game parameters and other information. Game parameters from software game modules may include scoring algorithms, play data, and other game specifics. Other data may be received and appropriately processed at server 150.

Console system 160 may provide functions that may be utilized by some or all game applications, whether single-player or multiple-player, for example. Console system 160 may support base components, multi-player game components and independent game components. Other components, functions and/or services may be provided as well.

One or more databases, as illustrated by 180 and 182, may store user specific information, game specific information, registration information, demographic information, prize/points information and other types of information. A single database or multiple databases may be used by the system to store various types of data. For example, trivia questions and other related data may be stored in a database in association with a trivia module. Information may be stored in a similar manner in association with prediction data and other game services.

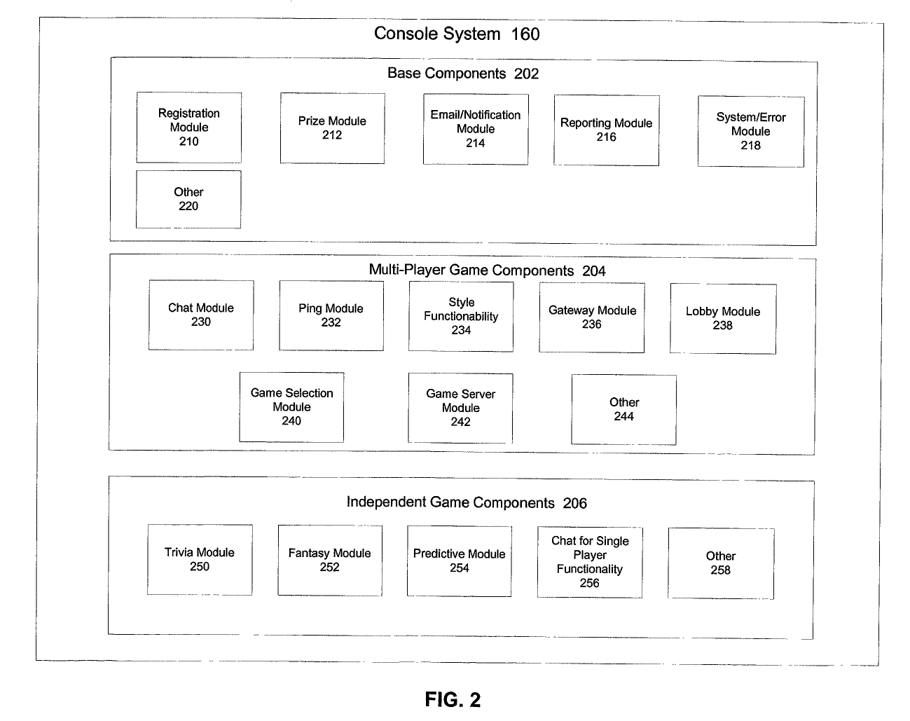

FIG. 2 is an example of a block diagram of a console system, according to an embodiment of the present invention. Console system 160 located at server 150 may provide a set of functionality modules that may be utilized by interactive games and other applications provided through various software game (or other) modules. Parameters may be passed to the console where the appropriate set of modules, functions and/or services may be invoked to provide the desired capabilities.

Upgrades, maintenance, additional functionality and other modifications to game software may be accomplished at the server. Console system 160 may be modified (e.g., upgraded) accordingly to provide upgrades, enhancements, corrections, and/or other functionality for use with software game modules. Thus, the user does not need to upgrade user-side systems and/or software because upgrades and maintenance functions may occur at the server.

Console system 160 may include base components 202, multi-player game components 204, independent game components 206 and other components for advanced functionality. In particular, base components 202 may include various combinations of Registration module 210, Prize module 212, Email/Notification module 214, Reporting module 216, System/Error module 218, and other modules 220. Multi-player game components may include various combinations of Chat module 230, Ping module 232, Style functionality 234, Gateway module 236, Lobby module 238, Game Selection module 240, Game Server module 242 and other module 244. Independent game components 206 may include various combinations of Trivia module 250, Fantasy module 252, Predictive modules 254, Chat for single player functionality 256 and other module 258. Modules may communicate with other modules and/or other segments of the present invention. For example, information regarding opted-in players collected by the Registration module may be forwarded to the Email/Notification module.

Base components may provide functionality that may be used by some or all software game modules, including single and/or multi-player game applications. Registration module 210 may include registration and other user data services. Registration module 210 may collect player data, such as personal data, identification data, contact data (e.g., email address) and other registration data. For example, player entry into a game application may be validated, by noting required and/or optional information, such as user password and other user identifiers. Demographic data may be collected where the system may be flexible to handle unforeseen requests for demographic information. For example, on-the-fly demographic requests may be supported by the present invention, as opposed to having a predefined list of acceptable demographic questions. For example, if a participant answers a particular question in the affirmative, a set of questions may be triggered based on that answer while other less relevant questions may be skipped automatically. In addition, players registering only once for a given group of games for a particular brand or client may be accommodated. For example, games may be grouped together where registration for one game in the group may provide for registration in all games in the group.

Registrants may also opt in and/or opt out of receiving information from service providers, sponsors and other entities. For example, a registrant may request email notifications of new games and/or other opportunities. This information and other registration data may be forwarded to other modules, such as Email/Notification module.

Registrants may also request personalized alerts and notifications regarding specific game start times, prize/award updates, point status information, other players (e.g., competitors) performance information, and other triggers and user defined events. Registration module may also maintain game statistics. For example, competitor win/lose records may be provided.

Prize Module 212 may include information related to types of prizes and other data, including the methodology in determining how winners may be awarded for each game or category of games. The present invention may provide various prize awarding systems. Prizes may be awarded based on an economy system, sweepstakes system, instant system, periodic system and other systems of awarding prizes. Prizes may include cash, merchandise, gift certificates, tickets, discounts, incentives, e-coupons and other forms of reward.

Under the economy system, accumulated points data for each player or groups of players may be maintained. The number and nature of points allocated to a contest under the economy system may be maintained as well. In addition, information related to which games participate in which economy may be stored and maintained. Threshold data may be applied and stored for various economy structures. For example, points may be awarded differently for accomplishing certain defined events. For example, a user may receive double points for successfully passing a stage of a game. Other variations may be implemented.

Under the sweepstakes system, pools of players may be determined and maintained. One or more winners may be determined through a lottery system or random draw system.

Under the instant system, information related to the number of points to win certain games may be maintained. In addition, information and statistics related to winners may be maintained as well. For example, this information may be passed to other modules within the system, such as email/notification module.

Under the periodic system, winners may be determined on a daily, weekly, monthly, or other time period. Awards may also be based on events or user defined conditions. For example, a winner may be determined by the most points within a predetermined time period. In addition, the player pool may be periodically reset.

Email/Notification module 214 may enable communication to a specific player, group of players and/or all players. General as well as targeted information may be communicated. Email/Notification module 214 may respond to information provided by other modules, such as Registration module 210. For example, players who have opted in receiving emails and other notifications may receive newsletters and/or other form of information on a regular basis (e.g., periodic, event driven, etc.). For example, an email may be sent each time a player participates in a game application. In another example, an email may be sent once per registrant. An event driven email may be sent to registrants regarding an event within a software game module. For example, participants may be informed that all questions will be from the 1950s in a trivia type game.

Email/Notification module 214 may be used to notify winners via email or other preferred mode of communication, such as phone, cell phone, PDA, wireless, Internet, and others. Targeted email/notifications may be sent to specific participants or groups of participants based on user history data (e.g., previously selected games), demographic data, preference data, profile data, and other information. Targeted emails/notifications may be used to solicit participants in tournaments based on previously selected games, demographics and/or other factors. In addition, based on previous scores, skill levels and other performance factors, competitive match-ups may be established in organizing tournaments. For example, a player with a high score in a particular game may be targeted to participate in a tournament of fellow competitors of similar skill level.

In another example, Email/Notification module 214 may be used to send batch-emails to registrants, general players based on game events, winners, opted-in users and other users.

Currently, an email system is set up separately for each game and tested on an individual basis. However, various inefficiencies and disadvantages exist to a separate email system for each game. The present invention provides a centralized email notification system wherein emails (or other forms of communication) for a particular game may behave more predictably and consistently. In addition, the centralized email notification system of the present invention enables games to be faster and cheaper to implement.

Reporting module 216 may provide reports of various events and/or occurrences. For example, reports related to player traffic, winner reports, player demographics and other relevant information. For example, reports may be based on the entire system, a particular game, groups/categories of games, and other user defined segments. Reports may further include sorting functions, search functions, tracking functions and other capabilities for analysis and other purposes.

System/Error module 218 may address system problems, system errors, application errors, questions and other matters related to the system. A feedback system may be implemented which may consist of a form on a user page (e.g., game page or a shell page) in which players may report bugs or give other feedback and/or suggestions, for example.

System/Error module 218 may address error tracking, error handling, system failure notification and other functions and services. Thus, information provided by System/Error module 218 may facilitate determining the cause when there is a malfunction of one or more of server, database, Web-logic, software code, game code or other component of the present invention.

Multi-player game components 204 may support various functions and modules associated with multiple player interactive game applications. A gateway and lobby functionality of the present invention may enable participants to enter, register, receive/accumulate points, maintain an account, and/or perform other operations. For example, a gateway may provide a list of lobbies with functionality to limit the number of players in each lobby. In each lobby, a list of games and/or players, chat capabilities and/or other services may be provided, for example. From the lobby, participants may select game sessions, from a selection of a plurality of games provided in the different lobbies. A game server may provide access to the game application and enable interactive capabilities. Game functionality may plug into the server's console system to provide scoring, points, chat, branding, advertisements and other services.

According to another embodiment of the present invention, multi-player game components may include one or more of Chat module 230, Ping module 232, Style functionality 234, Gateway module 236, Lobby module 238, Game Selection module 240, Game Server module 242 and other module 244.

For example, Chat function 230 may enable users to send private messages to one or more other users. Messages may be in the form of email, an instant message, a chat message, bulletin board or other format. Messages may be sent during a game or at other times. For example, a user may invite one or more users to join in a game and/or tournament. The system, sponsor or other entity may send broadcast messages to all users, group of users or other defined sets of users. The chat functionality may also include profanity filters which may filter word usage based on various levels of filtration (e.g., age levels, etc.). In addition, the chat functionality may use a live person to monitor word usage and other activities. Also, other combinations of filtering methods and security may be implemented. A user may also select to ignore one or more identified users. In addition, a ping function 232 may be used to check and/or eject unresponsive (or dead) players.

Style functionality 234 may enable players to select a type of competition. For example, the present invention may enable a player to participate in games with other players on a game-by-game basis. In addition, the player may participate in a series of games within a tournament. The present invention may support various types of multi-player tournament styles, such as a lobby style, a ladder style, a bracket style and other tournament style. The lobby style may enable any player to join any game and play any player (or players). Ranking may depend on who has won the most games. The ladder style may enable one player to challenge another player above him. If the lower ranking player wins, the players may then switch ranks. The bracket style is similar to a title drive with multiple players. After some beginning players conclude a game, the winner may play the winner of another beginning game. The winner of that game may play the winner of another intermediate game and so on. Different software game modules may be used for different tournament styles. Tournaments may also be segmented based on skill level, score data, and other performance information. For example, tournaments may include a beginner's tournament, intermediate tournament, expert tournament and other variations.

Gateway module 236 provides information related to lobbies, lobby status, and is player data. Lobby module 238 provides information related to games available, player data, chat capabilities, menu options, tournament functionality and other options. Game selection module 240 enables a user to select a game for participation, which may include viewing or playing, for example. Game server module 242 enables a user to access a game as provided by a software game module.

Independent game components 206 may provide various game functionality and services to the system of the present invention. Game services 206 may be independent or associated with the system. For example, game services 206 may provide a trivia module 250, fantasy module 252, prediction engine 254, chat capability 256 (e.g., for single player applications), and other functionality. Base components and game components may be invoked for single player as well as multiple player game applications.

For example, trivia module 250 provides games in which participants may be asked questions, such as questions related to real-time events. For example, players may be presented with trivia questions related to a particular award show (e.g., the Oscars) during a broadcast of the award show for points that may be redeemed through the system. In another example, players may be divided into teams based on the team they support and play group trivia games against opponents based on real-time events, such as football games, including interactive questions during the game. In addition, the real-time events may include games provided as part of the digital television broadcast of the real-time events or such a game provided on an Internet site at which the real-time event is occurring.

The trivia based module may provide a database of trivia questions. Individual games may provide trivia parameters to the database for access to a set of trivia questions for use with a software game module. Trivia parameters may include categories (e.g., movie, music, history, celebrity, science, politics, world events, etc.), level of difficulty (e.g., beginner, intermediate, expert, etc.), type (e.g., factoid, multiple choice, fill-in, etc.), time periods (e.g., 70's, 1990-1991, 17^{th} century, etc.) and other parameters. Categories may include various levels of sub-categories to provide detailed and comprehensive categories of trivia questions that the software game module may select. For example, a software game module may enable real-time interactive competition with other players based on award show trivia (e.g., Oscar trivia). For example, during a broadcast of an award show, such as the Oscars, a software game module may access a trivia module. Parameters specific to trivia associated with Oscars and nominated actors may be provided. During the broadcast of the Oscars, trivia questions related to live events may be displayed where participants may answer and compete with other participants or play in single player mode. For example, as the presenters for best actor are displayed, a trivia question related to who won the best actor award in 1990 may be displayed. Varying levels of difficulty and different types of questions (e.g., factoid, multiple choice, fill in the blank, etc.) may be implemented.

A trivia database enables software game modules the ability to access a repository of comprehensive trivia questions through detailed parameters. Thus, individual software game applications do not need to create trivia questions for each game application. In addition, the trivia database may be updated periodically so that software game modules may access current, up-to-date trivia data.

Fantasy module 252 may provide games in which participants may select players in a real-time sporting event and during the broadcast of the sporting event, may be provided output indicating their performance from the server system, including such a game provided as part of the digital television broadcast of the real-time event or such a game provided on an Internet site which the real-time event is occurring.

Predictive module 254 provides games in which participants may input predictions based on real-time events. For example, players may predict football plays. In this example, the system may receive multiple player's inputs and then output to the player systems whether the prediction was accurate where points may be awarded accordingly. In addition, such a game may be provided as part of the digital television broadcast of a real-time event or such a game provided on an Internet site at which the real-time event is occurring.

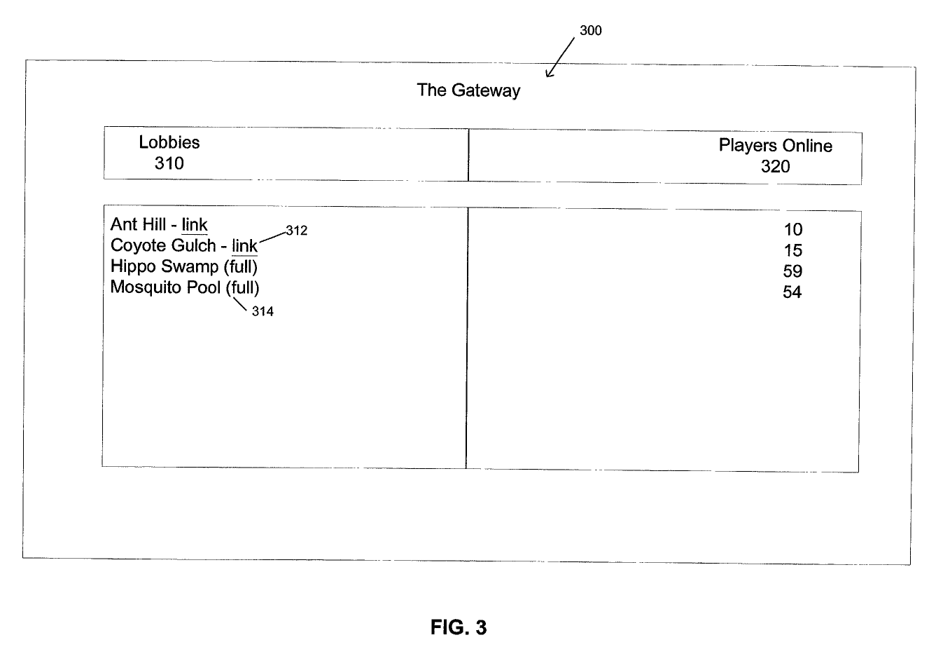

FIG. 3 is an example of a screen shot of a gateway for multi-player level functionality, according to an embodiment of the present invention. A gateway displays a list of lobbies, status data, participant data, and/or other information. A lobby may provide information related to current games, including player data, game options (e.g., watch, join, etc.), chat capability. At the lobby page, the user may select a game option, which may include watch, join, create, invite, etc. In addition, the user may join a tournament with other competitors. From the lobby page, the user may be taken to a game page of a selected game for participation.

A gateway, as illustrated by 300, may allow players to enter into a lobby, which is not yet full (or closed). The gateway may include a list of lobbies 310, a number of players 320 listed in each lobby, status data (e.g., open, full, closed, etc.), geographic location, and/or other relevant data. For example, some of the lobbies may be open where more players may participate. If a lobby is not yet full (e.g., open, pending, etc.), a link 312 may be provided to enable the user to enter that lobby to select a game to view or participate. Other lobbies may be fall (or closed), indicating that no other players may participate, as shown by 314. Other information may also be provided. The present invention may support a maximum number of players per lobby and a maximum number of lobbies per game. Other restrictions may be imposed. Other information and other formats may be implemented as well.

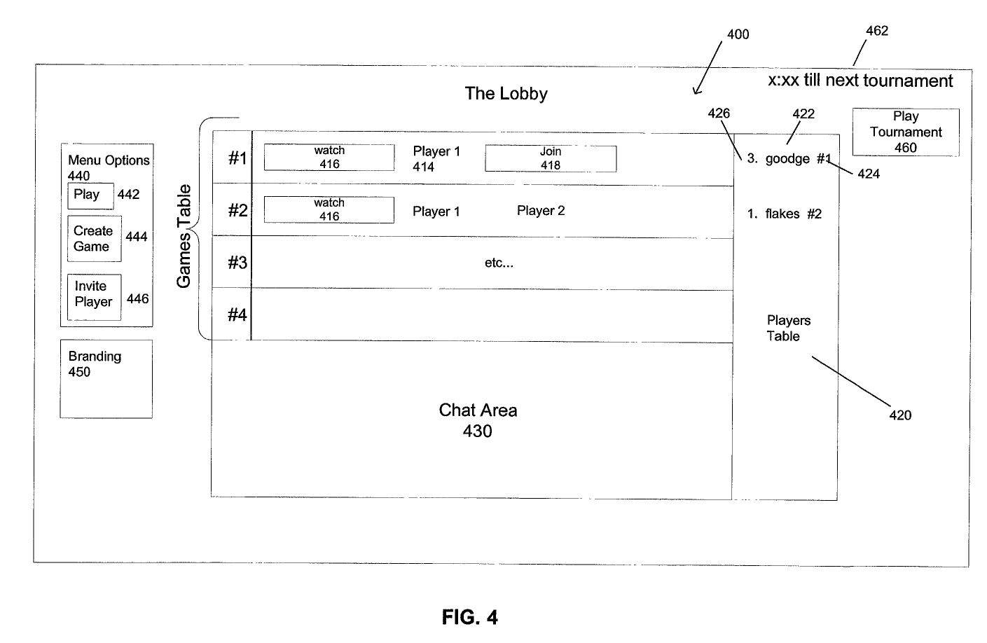

FIG. 4 is an example of a screen shot of a lobby for multi-player level functionality, according to an embodiment of the present invention. The lobby may contain games table 410, players table 420, chat area 430, menu options 440, branding 450 and/or other data.

Game table 410 may include a game number (or other identifier) 412, players 414, and game options, such as watch 416, join 418 and other actions, for example. A player may view a list of current games so that the player may observe or view the game. In addition, a player may view a list of games that are open so that the player may join the game. Games may also be designated as being private or public games. Private games may require a security mechanism for participation, such as a password. Game table 410 may also list which players are in which games. In another example, for a bracket system, the game brackets and/or relationships may be displayed.

Player table 420 may include a nickname or other identifier of each player 422 and the game number 424 associated with the game application with which the player is participating in. In addition, player table 420 may display each player's rank 426 or other player status data. Player table 420 may display who is currently available to play, who is currently playing a particular game, player ranking, top scores, and other related information.

Chat area 430 may enable players to communicate with each other. For example, the chat area may be restricted to those players within the lobby. Other chat restrictions may be applied. A player may also have the ability to ignore one or more particular users (which may include current players in the same game application and other identified users). Messaging capabilities may also be available. For example, a user may invite another user to play through an instant messaging service or other communication method. In addition, a user may page (or otherwise contact) another user to participate in a game. Other communication options may also be implemented.

Menu options 440 may include a play option 442, create a game option 444, invite player option 446 and other options. Lobby 400 may also include areas for branding, as illustrated by 450. Branding 450 may be placed in other areas within the lobby screen. For example, branding may be displayed across the bottom of the screen, along the top and/or sides of the screens or other area within the screen. Branding may enable sponsors or other entities to present logos, advertisements, incentives and other messages, which may be general or targeted to a specific user. Other information and other formats may be implemented.

According to an embodiment of the present invention, a ranking system may be implemented where players may be separated based on their skill in a game application. In this example, player table 420 may include each player's rank 426. In another example, a color coded key may be used to indicate player's ranks. Other methods of identifying ranks may be used as well.

According to an embodiment of the present invention, a bracket (or other) tournament may be implemented where users may play a tournament in real time. To adjust for a bracket tournament, a bracket style tournament button (or other icon) may be displayed in lobby 400, as illustrated by 460. Clock 462 may indicate how much time is left until the next tournament begins. Other time measuring displays may be used as well.

A bracket tournament may determine a winner by process of elimination. The bracket tournament may enable players to play against each other in real time. Players may start in the outer brackets. Winners from the outer brackets may play against one another to further determine winners. Players who lose may be eliminated A loser bracket may be available. If there are not enough players, robots may play in their place, as further described below.

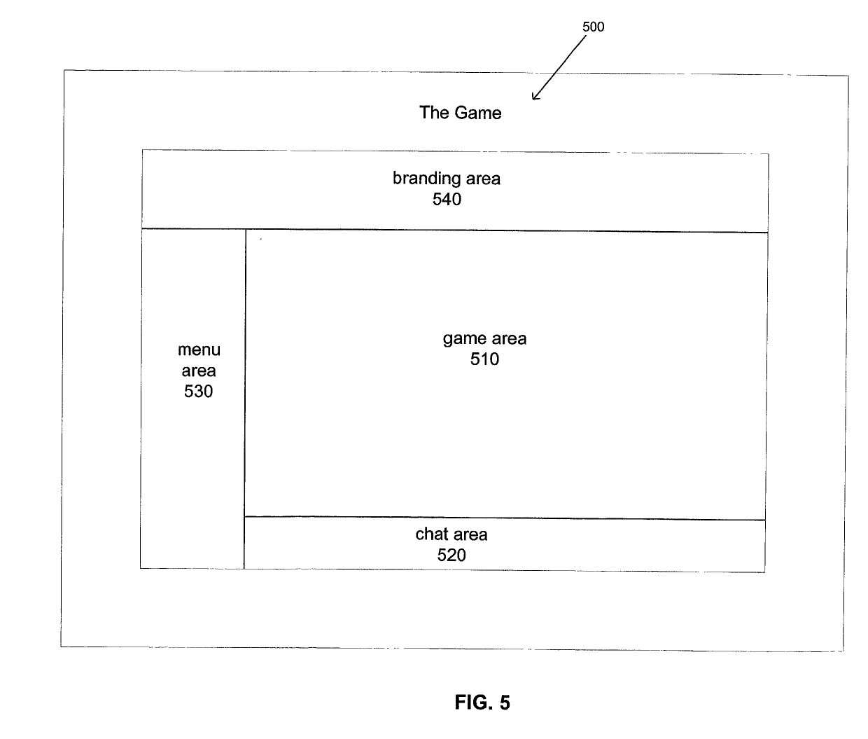

FIG. 5 is an example of a screen shot of a game page for multi-player level functionality, according to an embodiment of the present invention. Game page 500 may include game area 510, chat area 520, menu area 530, branding area 540 and/or other data. Game area 510 may support various game applications and options, which may include avatars, scores, game boards (e.g., trivia questions, courts, fields, etc.) game grids and other game application environments. Chat area 520 may enable users to communicate with each other. For example, the chat area may be restricted to those players within the game. Menu area 530 may enable a player to perform various options, such as start game, exit, pause, replay, skip, and other operations. In addition, winners, scores and other data may be reported to console components, such as a registration module, for example. Branding 540 may enable a sponsor (or other entity) to present a logo, banner, message, incentives, promotions and other information. Other information and other formats may be implemented.

According to another embodiment of the present invention, a robot or other automated player may participate in a multi-player game application. This function may be available under various circumstances. For example, if a player is pinged and/or not responding, a robot player may be invoked to continue the game. In another example, if there are not enough people in the lobby, within a certain time-period a robot may appear to play. Various features may be customizable to a software game module. Players may also be given a choice. For example, if there are not enough players, the players may be asked if they want to play anyway with a robot. Robots may or may not be identified. A robot's name may be displayed in a different appearance, such as font, color, size of font, etc. Also, a robot's name may indicate that they are robots, such as Robot_{—}1 or MeanRobot, for example. Other features and options of a robot may be customized.

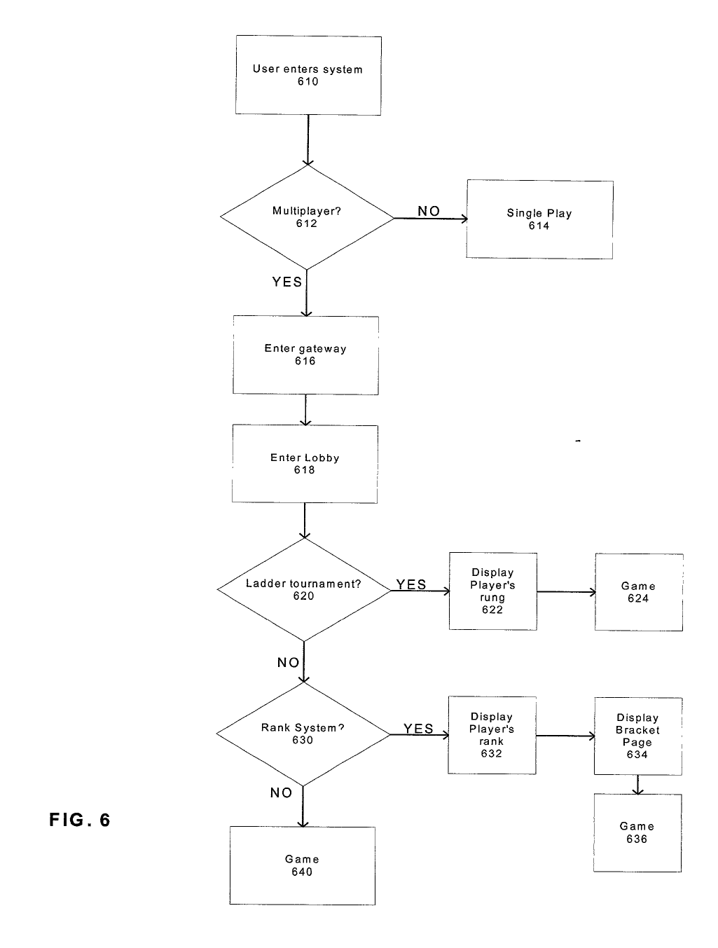

FIG. 6 is an example of a flowchart for participating in a multi-player interactive game, according to an embodiment of the present invention. At step 610, a user may enter the system of the present invention via various modes of communication. For example, the user may access the system through a digital television, the Internet or other mode of communication for participation in an interactive game based on real time events. The user may then select or provide information related to the type of game or play. For example, it may be determined whether single play or multi-player play may be desired, at step 612. A user may participate in a single play game application, at step 614. Various game services may be invoked for a single play game. If the user desires a multi-player interactive game, the user may proceed to a gateway, at step 616. From the gateway, the user may enter a lobby, at step 618. It may then be determined what type of multi-player system may be applied. For example, if the user selects ladder tournament, at step 620, the player's rung may be displayed at 622 and the user may enter a game within a ladder tournament at step 624. If the user selects a ranking system, at step 630, the player's rank may be displayed at 632. The user may then be taken to a bracket page 634 and participate in a game within a ranking system tournament, at step 636. As a default, the user may enter a multi-player game, at step 640. Other tournament and multi-player game structures may be implemented.

As described above, various components have been described. It should be appreciated that user devices may be or include, for instance, a personal computer running the Microsoft Windows™ 95, 98, Millenium™, NT™, or 2000, Windows™CE™, PalmOS™, Unix, Linux, Solaris™, OS/2™, BeOS™, MacOS™, VAX VMS or other operating system or platform. User devices may include a microprocessor such as an Intel x86-based device, a Motorola 68K or PowerPC™ device, a MIPS, Hewlett-Packard Precision™, or Digital Equipment Corp. Alpha™ RISC processor, a microcontroller or other general or special purpose device operating under programmed control. User devices may furthermore include electronic memory such as RAM (random access memory) or EPROM (electronically programmable read only memory), storage such as a hard drive, CDROM or rewritable CDROM or other magnetic, optical or other media, and other associated components connected over an electronic bus, as will be appreciated by persons skilled in the art. User devices may also be or include a network-enabled appliance such as a WebTV™ unit, radio-enabled Palm™ Pilot or similar unit, a set-top box, a networkable game-playing console such as Sony Playstation™ or Sega Dreamcas™, a browser-equipped or other network-enabled cellular telephone, or other TCP/IP client or other device.

Server 150 may be or include, for instance, a workstation running the Microsoft Windows™NT™, Windows™ 2000, Unix, Linux, Xenix, IBM AIX™, Hewlett-Packard UX™, Novell Netware™, Sun Microsystems Solaris™, OS/2™ , BeOS™, Mach, Apache, OpenStep™ or other operating system or platform.

Databases 180, 182 may be, include or interface to, for example, the Oracle™ relational database sold commercially by Oracle Corp. Other databases, such as Informix™, DB2 (Database 2), Sybase or other data storage or query formats, platforms or resources such as OLAP (On Line Analytical Processing), SQL (Standard Query Language), a storage area network (SAN), Microsoft Access™ or others may also be used, incorporated or accessed in the invention.

The present invention thus provides a series of features and services for multiple web-based game products with generic, scalable instances of various services. Quicker and more cost efficient development cycles for new and updated products are thereby realized. Uniformity of base level code may be established across products and/or product lines thereby promoting consistency. The present invention also provides ease in functional upgrades, customization and easily accommodates improvements and additions.

Other embodiments, uses and advantages of the present invention will be apparent to those skilled in the art from consideration of the specification and practice of the invention disclosed herein. The specification and examples should be considered exemplary only. The intended scope of the invention is only limited by the claims appended hereto.

What is claimed is:

1. A system for providing functionality to remote users at individually addressable systems, the system comprising:
one or more servers in communication with one or more remote user systems wherein the remote user systems are individually addressable;
one or more console systems operating on the one or more servers wherein the console systems comprise one or more base-functionality modules; and
one or more software game modules that utilize functionality provided by the console system to provide interactive game content to the remote user system;
wherein one or more parameters are received from the remote user system at the console system;
wherein the software game module passes game-specific information to the console system; and
wherein the console system communicates with the remote user system using a base-functionality module in a manner determined by the game-specific information.

2. The system of claim 1 wherein the console system further comprises one or more multi-player functionality modules.

3. The system of claim 1 wherein the console system further comprises one or more game service modules.

4. The system of claim 1 wherein the base functionality modules comprise one or more of registration module, prize module, email module, notification module, reporting module, and system/error module.

5. The system of claim 2 wherein the multi-player functionality modules comprise one or more of chat module, ping module, style functionality, gateway module, lobby module, game selection module, and game server module.

6. The system of claim 3 wherein the game service modules comprise one or more of trivia module, fantasy module, predictive module and chat for single play module.

7. The system of claim 2 wherein the multi-player functionality module comprises a gateway module that generates a list of games and player data.

8. The system of claim 2 wherein the multi-player functionality module comprises a lobby module that contains game data, player data, menu options, and chat functionality.

9. The system of claim 1 wherein the interactive game content comprises a real-time event displayed on the remote user system.

10. The system of claim 9 wherein the remote user system comprises one or more of television, digital television, computer monitor, and wireless device.

11. A method for providing functionality to remote users at individually addressable systems, the system comprising the steps of:
communicating with one or more remote user systems wherein the remote user systems are individually addressable;
operating a remote console system wherein the console system comprises one or more base functionality modules;
providing interactive game content to the remote user system via a software game module that utilizes one or more base functionality modules; and
communicating one or more parameters from the remote user system to the console system;
wherein the software game module passes game-specific information to the console system; and wherein the console system communicates with the remote user system using a base-functionality module in a manner determined by the game-specific information.

12. The method of claim 11 wherein the console system further comprises one or more multi-player functionality modules.

13. The method of claim 11 wherein the console system further comprises one or more game service modules.

14. The method of claim 11 wherein the console system is operating at a central server.

15. The method of claim 11 wherein the base functionality modules comprise one or more of registration module, prize module, email module, notification module, reporting module, and system/error module.

16. The method of claim 12 wherein the multi-player functionality modules comprise one or more of chat module, ping module, style functionality, gateway module, lobby module, game selection module, and game server module.

17. The method of claim 13 wherein the game service modules comprise one or more of trivia module, fantasy module, predictive module and chat for single play module.

18. The method of claim 12 wherein the multi-player functionality module comprises a gateway module that generates a list of games and player data.

19. The method of claim 12 wherein the multi-player functionality module comprises a lobby module that contains game data, player data, menu options, and chat functionality.

20. The method of claim 11 wherein the interactive game content comprises a real-time event displayed on the remote user system.

21. The method of claim 19 wherein the remote user system comprises one or more of television, digital television, computer monitor, and wireless device.
